(19) United States
(12) Patent Application Publication
(10) Pub. No.: US 2017/0192587 A1
(43) Pub. Date: Jul. 6, 2017

(54) TOUCH CONTROL SUBSTRATE, MANUFACTURING METHOD THEREOF AND DISPLAY PANEL

(71) Applicants: BOE TECHNOLOGY GROUP CO., LTD., Beijing (CN); CHENGDU BOE OPTOELECTRONICS TECHNOLOGY CO., LTD., Chengdu (CN)

(72) Inventors: Zhengdong ZHANG, Beijing (CN); Haoyuan FAN, Beijing (CN); Zailong MO, Beijing (CN)

(21) Appl. No.: 15/255,014

(22) Filed: Sep. 1, 2016

(30) Foreign Application Priority Data
Jan. 4, 2016 (CN) 201610004334.5

(51) Int. Cl. G06F 3/041; G06F 3/044

(52) U.S. Cl. CPC G06F 3/0416; G06F 3/0412; G06F 3/044; G06F 2203/04103; G06F 2203/04104

(57) ABSTRACT

The embodiments of the present invention provide a touch control substrate, manufacturing method thereof and a display device, eliminating the shadow phenomenon in the prior art caused by the reflected light on the edge of the ITO layer. The touch control substrate comprises a wiring region and a touch control region. The wiring region comprises a shadow elimination layer with a plurality of first zigzag slits; the touch control region comprises a touch control electrode with a plurality of second zigzag slits. The first zigzag slit is not parallel to the second zigzag slit.

### RELATED APPLICATIONS

The present application claims the benefit of Chinese Patent Application No. 201610004334.5, filed on Jan. 4, 2016, the entire disclosure of which is incorporated herein by reference.

### TECHNICAL FIELD

The present invention relates to the field of touch control technology, particularly to a touch control substrate, manufacturing method thereof and a display panel.

### BACKGROUND

Touch control panel is an input device that allows a user to directly input user's instruction with a hand or an object, by selecting instruction content displayed on a screen such as an image display. When the user directly touches the touch control panel with a hand or an object, the touch control panel detects the touch point and drives the liquid crystal display device according to the command of the selected icon, realizing specific display. Nowadays the touch control technology is applied in the display electronic products (such as smart phones and displays) more and more widely. At present, in order to realize the function of multi-point touch control, capacitive touch control screen technology is widely used in the screens of medium and small size. According to different structures, capacitive touch screen technology comprises three types: Out-cell, In-cell and On-cell. The On-cell technology is a focus in the industry due to good tactility, lightness, small thickness and low cost.

At present, the mainstream structure used in capacitive touch control screen applies a layer of Indium Tin Oxide (ITO) as a touch control electrode layer; that is, a layer of ITO is deposited on glass. After an ITO electrode pattern is formed with lithography and etching, by adding insulation bridges, metal conductive lines, protective layer and so on, touch control sensor such as OGS structure (i.e.: glass/insulating frame/ITO or glass/insulating frame/shadow elimination layer/ITO) or G/G structure (i.e.: a piece of glass for touch sensor, and a piece of glass as a protective glass) is then formed.

However, after the ITO layer is etched to form a patterned area and a non patterned area, since the reflectivity difference of these two areas is very large, the etching texture is relatively obvious, resulting in the loss of visual effect. In the prior art, the problem can be solved by depositing a single layer or a multilayer structure consisting of niobium pentaoxide film and silicon dioxide film between the substrate and the electrode, but the effect is not ideal. Moreover, in these solutions, if it is required to observe the effect of shadow elimination, the observation should be carried out after the ITO layer is etched into the pattern, taking a long time; if the effect of shadow elimination is not good, a great loss will be inevitable.

### SUMMARY

The embodiments of the present invention provide a touch control substrate, manufacturing method thereof and a display device, eliminating the shadow phenomenon in the prior art caused by the reflected light on the edge of the ITO layer.

To this end, an embodiment of the present invention provides a touch control substrate. The touch control substrate comprises a wiring region and a touch control region; the wiring region comprises a shadow elimination layer with a plurality of first zigzag slits; the touch control region comprises a touch control electrode with a plurality of second zigzag slits; the first zigzag slit is not parallel to the second zigzag slit.

In the touch control substrate provided by the embodiment of the present invention, the first zigzag slit is not parallel to the second zigzag slit, therefore light reflected by the plurality of first zigzag slits and light reflected by the plurality of second zigzag slits will not be concentrated in a certain direction. The pattern of the touch control electrode does not appear on the screen, improving the effect of shadow elimination.

Optionally, the shadow elimination layer and the touch control electrode are arranged in the same layer.

The touch control electrode in the touch control region can typically be formed with ITO material. By arranging the shadow elimination layer and the touch control electrode in the same layer, the preparation process is simplified, the production cost is reduced, and the production cycle is shortened. Moreover, by arranging the shadow elimination layer and the touch control electrode in the same layer, the shadow elimination layer and the touch control electrode can then be made of the same material and have the same reflectivity. The visual effect will not be reduced; otherwise the etching texture will be very obvious due to a relatively great difference in reflectivity between the shadow elimination layer and the touch control electrode.

Optionally, the bending direction of the first zigzag slit is contrary to the bending direction of the second zigzag slit. Alternatively, the bending direction of the first zigzag slit is same with the bending direction of the second zigzag slit; the bending angle of the first zigzag slit is different with the bending angle of the second zigzag slit.

With such a configuration, the reflected light can be further diffused into more directions, avoiding light reflected by the touch control electrode being concentrated in a certain direction, thereby improving the effect of shadow elimination and improving the display uniformity.

Optionally, the touch control electrode comprises a touch driving electrode and a touch sensing electrode arranged in the same layer; the touch driving electrode and the touch sensing electrode comprise the second zigzag slits respectively.

With the plurality of second zigzag slits, the touch driving electrode and the touch sensing electrode can provide touch control function, and the edge of the touch control electrode is not obvious any more.

Optionally, the second zigzag slit of the touch driving electrode is not parallel to the second zigzag slit of the touch sensing electrode.

By arranging the second zigzag slit of the touch driving electrode and the second zigzag slit of the touch sensing electrode in such a manner, the effect of shadow elimination can be improved effectively within the touch control electrode; the display uniformity can be further improved.

Optionally, to further improve the display uniformity, the bending direction of the second zigzag slits of the touch driving electrode is arranged to be contrary to the bending direction of the second zigzag slits of the touch sensing electrode. Alternatively, the bending direction of the second zigzag slits of the touch driving electrode is same with the bending direction of the second zigzag slits of the touch sensing electrode; the bending angle of the second zigzag slits of the touch driving electrode is different with the bending angle of the second zigzag slits of the touch sensing electrode.

Optionally, the touch control region further comprises a gap region with a plurality of third zigzag slits, the gap region being arranged between the touch driving electrode and the touch sensing electrode; the third zigzag slit is not parallel to the second zigzag slit.

If the touch driving electrode and the touch sensing electrode are arranged in the same layer, a gap region should be arranged in the touch control region for isolating the touch driving electrode from the touch sensing electrode. By arranging the third zigzag slits in such a manner, light reflected by the edge of the touch control electrode can be further diffused, improving the display uniformity of the display panel.

Based on the same creative concept, an embodiment of the present invention provides a display panel. The display panel comprises the above mentioned touch control substrate.

Based on the same creative concept, an embodiment of the present invention provides a method for manufacturing a touch control substrate. The method comprises: forming a wiring region and a touch control region; and forming a shadow elimination layer with a plurality of first zigzag slits in the wiring region. The touch control region comprises a touch control electrode with a plurality of second zigzag slits; the first zigzag slit is not parallel to the second zigzag slit.

In the touch control substrate manufactured by the method of the embodiment, the first zigzag slit is not parallel to the second zigzag slit, therefore light reflected by the plurality of first zigzag slits and light reflected by the plurality of second zigzag slits will not be concentrated in a certain direction. The pattern of the touch control electrode does not appear on the screen, improving the effect of shadow elimination.

Optionally, the shadow elimination layer and the touch control electrode are arranged in the same layer.

The touch control electrode in the touch control region can typically be formed with ITO material. By arranging the shadow elimination layer and the touch control electrode in the same layer, the preparation process is simplified, the production cost is reduced, and the production cycle is shortened. Moreover, by arranging the shadow elimination layer and the touch control electrode in the same layer, the shadow elimination layer and the touch control electrode can then be made of the same material and have the same reflectivity. The visual effect will not be reduced; otherwise the etching texture will be very obvious due to a relatively great difference in reflectivity between the shadow elimination layer and the touch control electrode.

Optionally, the touch control electrode comprises a touch driving electrode and a touch sensing electrode arranged in the same layer; the step of forming a touch control region comprises: arranging the touch driving electrode and the touch sensing electrode in the same layer with a transparent material; forming a plurality of second zigzag slits on the touch driving electrode and the touch sensing electrode. The second zigzag slit of the touch driving electrode is not parallel to the second zigzag slit of the touch sensing electrode.

By arranging the second zigzag slit of the touch driving electrode and the second zigzag slit of the touch sensing electrode in such a manner, the effect of shadow elimination can be improved effectively within the touch control electrode; the display uniformity can be further improved.

Optionally, the method further comprises: forming a gap region with a plurality of third zigzag slits, the gap region being arranged between the touch driving electrode and the touch sensing electrode. The third zigzag slit is not parallel to the second zigzag slit.

If the touch driving electrode and the touch sensing electrode are arranged in the same layer, a gap region should be arranged in the touch control region for isolating the touch driving electrode from the touch sensing electrode. By arranging the third zigzag slits in such a manner, light reflected by the edge of the touch control electrode can be further diffused, improving the display uniformity of the display panel.

### BRIEF DESCRIPTION OF THE DRAWINGS

FIG. 1 is a structural schematic diagram of the first zigzag slits in the shadow elimination layer and the second zigzag slits in the touch control region provided by an embodiment of the present invention;

FIG. 2 is a structural schematic diagram of the first zigzag slits in the shadow elimination layer and the second zigzag slits in the touch control region provided by an embodiment of the present invention;

FIG. 3 is a structural schematic diagram of a touch control substrate comprising a touch driving electrode and a touch sensing electrode provided by an embodiment of the present invention;

FIG. 4 is a structural schematic diagram of a touch control substrate comprising a gap region provided by an embodiment of the present invention; and

FIG. 5 is a flow chart of a method for manufacturing a touch control substrate provided by an embodiment of the present invention; and

FIG. 6 is a flow chart of a method for manufacturing a touch control substrate provided by another embodiment of the present invention.

### DETAILED DESCRIPTION OF THE INVENTION

The embodiments of the present invention provide a touch control substrate, manufacturing method thereof and a display device, eliminating the shadow phenomenon in the prior art caused by the reflected light on the edge of the ITO layer.

In the following, the technical solutions in embodiments of the invention will be described clearly and completely in connection with the drawings in the embodiments of the invention. Obviously, the described embodiments are only part of the embodiments of the invention, and not all of the embodiments. Based on the embodiments in the invention, all other embodiments obtained by those of ordinary skills in the art under the premise of not paying out creative work pertain to the protection scope of the invention.

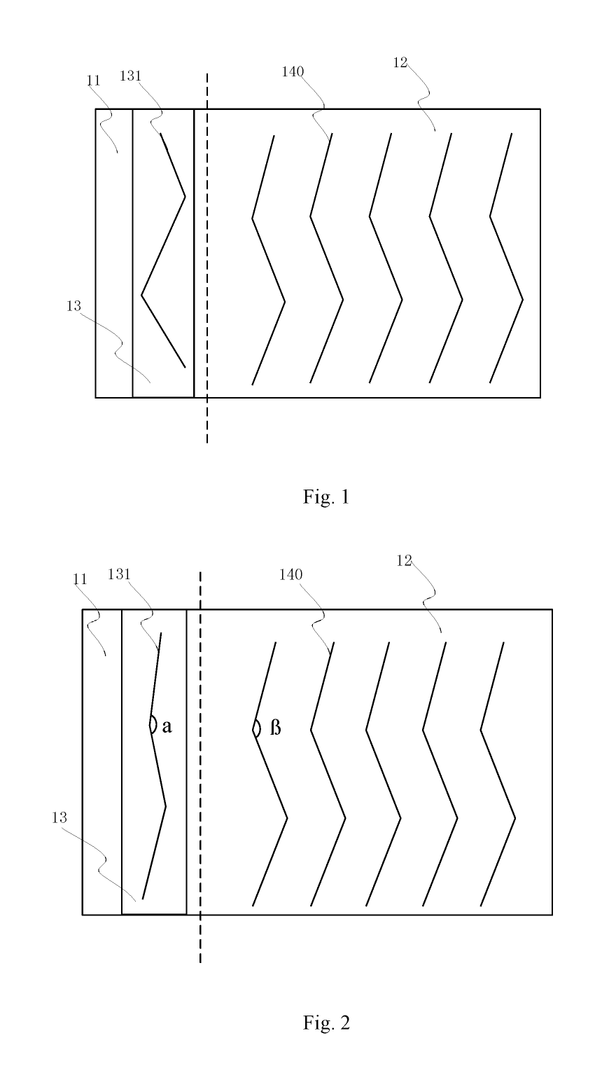

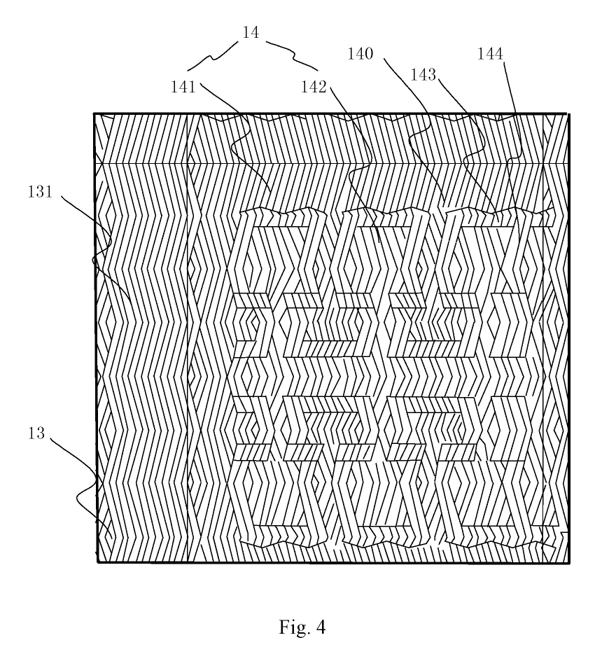

An embodiment of the present invention provides a touch control substrate. As shown in FIG. 1 and FIG. 3, the touch control substrate comprises a wiring region 11 and a touch control region 12; the wiring region 11 comprises a shadow elimination layer 13 with a plurality of first zigzag slits 131; the touch control region 12 comprises a touch control electrode 14 with a plurality of second zigzag slits 140; the first zigzag slit 131 is not parallel to the second zigzag slit 140.

In the touch control substrate provided by the embodiment of the present invention, the first zigzag slit is not parallel to the second zigzag slit, therefore light reflected by the plurality of first zigzag slits and light reflected by the plurality of second zigzag slits will not be concentrated in a certain direction. The pattern of the touch control electrode does not appear on the screen, improving the effect of shadow elimination.

Further, the shadow elimination layer 13 and the touch control electrode 14 are arranged in the same layer.

The touch control electrode in the touch control region can typically be formed with ITO material. By arranging the shadow elimination layer and the touch control electrode in the same layer, the preparation process is simplified, the production cost is reduced, and the production cycle is shortened. Moreover, by arranging the shadow elimination layer and the touch control electrode in the same layer, the shadow elimination layer and the touch control electrode can then be made of the same material and have the same reflectivity. The visual effect will not be reduced; otherwise the etching texture will be very obvious due to a relatively great difference in reflectivity between the shadow elimination layer and the touch control electrode.

In the context of the present invention, features “arranged in the same layer” refers to a plurality of features being arranged in the same layer, or a plurality of features being formed with a same layer of a certain material.

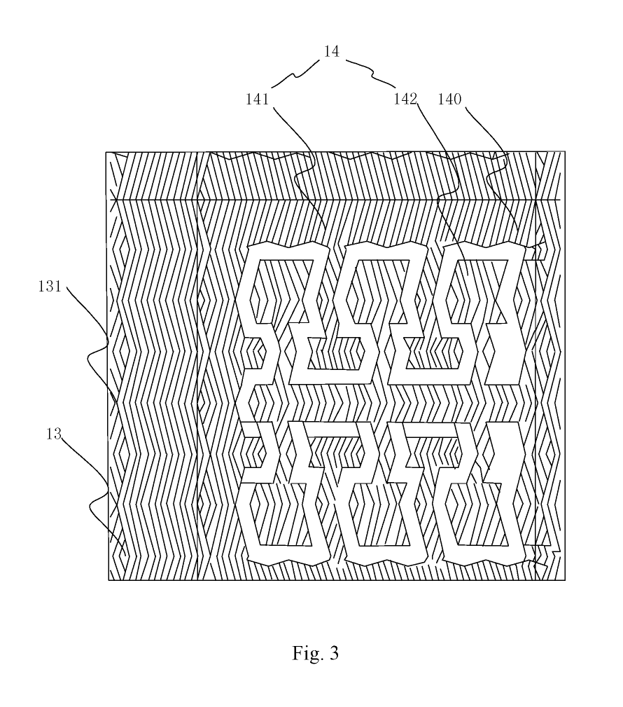

Further, in a specific technological design, as shown in FIG. 1, the bending direction of the first zigzag slit 131 is contrary to the bending direction of the second zigzag slit 140. Alternatively, as shown in FIG. 2, the bending direction of the first zigzag slit 131 is same with the bending direction of the second zigzag slit 140; the bending angle of the first zigzag slit 131 is different with the bending angle of the second zigzag slit 140; that is, the bending angle α of the first zigzag slit 131 is different with the bending angle β of the second zigzag slit 140.

With such a configuration, the reflected light can be further diffused into more directions, avoiding light reflected by the touch control electrode being concentrated in a certain direction, thereby improving the effect of shadow elimination and improving the display uniformity.

Further, as shown in FIG. 3, to achieve the touch control function, the touch control electrode 14 comprises a touch driving electrode 141 and a touch sensing electrode 142 arranged in the same layer; the touch driving electrode 141 and the touch sensing electrode 142 comprise the second zigzag slits 140 respectively.

With the plurality of second zigzag slits, the touch driving electrode and the touch sensing electrode can provide touch control function, and the edge of the touch control electrode is not obvious any more.

Optionally, the second zigzag slit 140 of the touch driving electrode 141 is not parallel to the second zigzag slit 140 of the touch sensing electrode 142.

By arranging the second zigzag slit of the touch driving electrode and the second zigzag slit of the touch sensing electrode in such a manner, the effect of shadow elimination can be improved effectively within the touch control electrode; the display uniformity can be further improved.

Optionally, to further improve the display uniformity, the bending direction of the second zigzag slits 140 of the touch driving electrode 141 is arranged to be contrary to the bending direction of the second zigzag slits 140 of the touch sensing electrode 142. Alternatively, the bending direction of the second zigzag slits 140 of the touch driving electrode 141 is same with the bending direction of the second zigzag slits 140 of the touch sensing electrode 142; the bending angle of the second zigzag slits 140 of the touch driving electrode 141 is different with the bending angle of the second zigzag slits 140 of the touch sensing electrode 142.

Further, as shown in FIG. 4, the touch control region 12 further comprises a gap region 143 with a plurality of third zigzag slits 144, the gap region 143 being arranged between the touch driving electrode 141 and the touch sensing electrode 142; the third zigzag slit 144 is not parallel to the second zigzag slit 140.

If the touch driving electrode and the touch sensing electrode are arranged in the same layer, a gap region should be arranged in the touch control region for isolating the touch driving electrode from the touch sensing electrode. By arranging the third zigzag slits in such a manner, light reflected by the edge of the touch control electrode can be further diffused, improving the display uniformity of the display panel.

To simplify the manufacture process and reduce the production cost, the third zigzag slits 144 in the gap region 143 are arranged in the same layer, avoiding the difference of the visual effect due to the reflectivity difference.

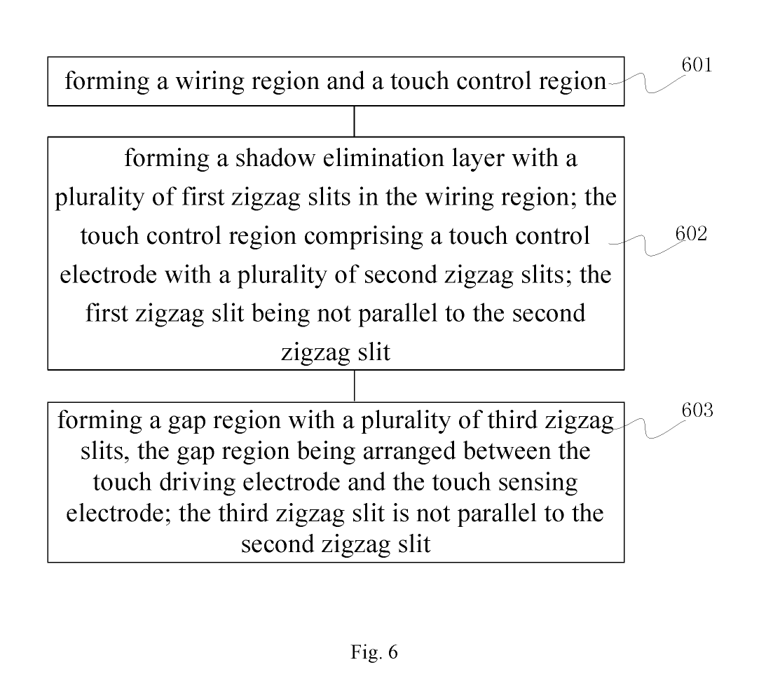

Based on the same creative concept, an embodiment of the present invention provides a method for manufacturing a touch control substrate. As shown in FIG. 6, the method comprises: step 601, forming a wiring region and a touch control region; and step 602, forming a shadow elimination layer with a plurality of first zigzag slits in the touch control region. The touch control region comprises a touch control electrode with a plurality of second zigzag slits; the first zigzag slit is not parallel to the second zigzag slit.

In the touch control substrate manufactured by the method of the embodiment, the first zigzag slit is not parallel to the second zigzag slit, therefore light reflected by the plurality of first zigzag slits and light reflected by the plurality of second zigzag slits will not be concentrated in a certain direction. The pattern of the touch control electrode does not appear on the screen, improving the effect of shadow elimination.

Optionally, the shadow elimination layer and the touch control electrode are arranged in the same layer.

The touch control electrode in the touch control region can typically be formed with ITO material. By arranging the shadow elimination layer and the touch control electrode in the same layer, the preparation process is simplified, the production cost is reduced, and the production cycle is shortened. Moreover, by arranging the shadow elimination layer and the touch control electrode in the same layer, the shadow elimination layer and the touch control electrode can then be made of the same material and have the same reflectivity. The visual effect will not be reduced; otherwise the etching texture will be very obvious due to a relatively great difference in reflectivity between the shadow elimination layer and the touch control electrode.

Further, the touch control electrode comprises a touch driving electrode and a touch sensing electrode arranged in the same layer; the step of forming a touch control region comprises: arranging the touch driving electrode and the touch sensing electrode in the same layer with a transparent material; forming a plurality of second zigzag slits on the touch driving electrode and the touch sensing electrode. The second zigzag slit of the touch driving electrode is not parallel to the second zigzag slit of the touch sensing electrode.

By arranging the second zigzag slit of the touch driving electrode and the second zigzag slit of the touch sensing electrode in such a manner, the effect of shadow elimination can be improved effectively within the touch control electrode; the display uniformity can be further improved.

Optionally, as shown in FIG. 6, the method further comprises: step 603, forming a gap region with a plurality of third zigzag slits, the touch control region being arranged between the touch driving electrode and the touch sensing electrode. The third zigzag slit is not parallel to the second zigzag slit.

If the touch driving electrode and the touch sensing electrode are arranged in the same layer, a gap region should be arranged in the touch control region for isolating the touch driving electrode from the touch sensing electrode. By arranging the third zigzag slits in such a manner, light reflected by the edge of the touch control electrode can be further diffused, improving the display uniformity of the display panel.

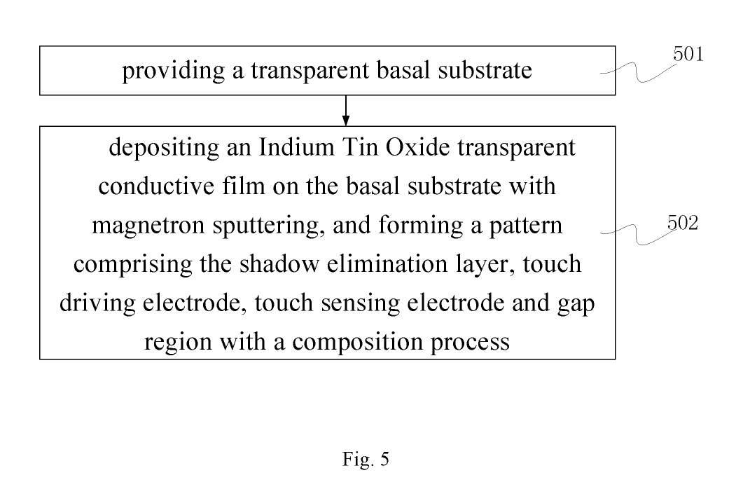

In the following, a method for manufacturing a touch control substrate will be introduced in connection with FIG. 5 and the touch control substrate provided by the embodiment of the invention. The method comprises: step 501, providing a transparent basal substrate; step 502, as shown in FIG. 4, depositing an Indium Tin Oxide transparent conductive film on the basal substrate with magnetron sputtering, and forming a pattern comprising the shadow elimination layer, touch driving electrode, touch sensing electrode and gap region with a composition process.

In this embodiment, the composition process can comprise: firstly, forming an ITO layer for the shadow elimination layer, touch driving electrode, touch sensing electrode and gap region (with magnetron sputtering or coating); then coating a layer of photoresist on the ITO layer; performing exposure to the photoresist with a mask plate having a pattern of the shadow elimination layer, touch driving electrode, touch sensing electrode and gap region; finally, forming the shadow elimination layer, touch driving electrode, touch sensing electrode and gap region with developing and etching process.

In the method for manufacturing the touch control substrate, the preparation process for the film layers relating to composition process can be same with the above mentioned composition process, which will not be repeated herein.

Based on the same creative concept, an embodiment of the present invention provides a display panel. The display panel comprises the above mentioned touch control substrate.

In conclusion, the embodiments of the present invention provide a touch control substrate, manufacturing method thereof and a display device. The touch control substrate comprises a wiring region and a touch control region; the touch control region comprises a shadow elimination layer with a plurality of first zigzag slits; the touch control region comprises a touch control electrode with a plurality of second zigzag slits; the first zigzag slit is not parallel to the second zigzag slit. In the touch control substrate provided by the embodiment of the present invention, the first zigzag slit is not parallel to the second zigzag slit, therefore light reflected by the plurality of first zigzag slits and light reflected by the plurality of second zigzag slits will not be concentrated in a certain direction. The pattern of the touch control electrode does not appear on the screen, improving the effect of shadow elimination.

The above embodiments are only used for explanations rather than limitations to the present invention, the ordinary skilled person in the related technical field, in the case of not departing from the spirit and scope of the present invention, may also make various modifications and variations, therefore, all the equivalent solutions also belong to the scope of the present invention, the patent protection scope of the present invention should be defined by the claims.

What is claimed is:

1. A touch control substrate comprising a wiring region and a touch control region;
wherein the wiring region comprises a shadow elimination layer with a plurality of first zigzag slits;
wherein the touch control region comprises a touch control electrode with a plurality of second zigzag slits;
wherein the first zigzag slit is not parallel to the second zigzag slit.

2. The touch control substrate according to claim 1, wherein the shadow elimination layer and the touch control electrode are arranged in the same layer.

3. The touch control substrate according to claim 1, wherein the bending direction of the first zigzag slit is contrary to the bending direction of the second zigzag slit.

4. The touch control substrate according to claim 1, wherein the bending direction of the first zigzag slit is same with the bending direction of the second zigzag slit; wherein the bending angle of the first zigzag slit is different with the bending angle of the second zigzag slit.

5. The touch control substrate according to claim 1, wherein the touch control electrode comprises a touch driving electrode and a touch sensing electrode arranged in the same layer; wherein the touch driving electrode and the touch sensing electrode comprise the second zigzag slits respectively.

6. The touch control substrate according to claim 5, wherein the second zigzag slit of the touch driving electrode is not parallel to the second zigzag slit of the touch sensing electrode.

7. The touch control substrate according to claim 5, wherein the bending direction of the second zigzag slits of the touch driving electrode is contrary to the bending direction of the second zigzag slits of the touch sensing electrode.

8. The touch control substrate according to claim 5, wherein the bending direction of the second zigzag slits of the touch driving electrode is same with the bending direction of the second zigzag slits of the touch sensing electrode; wherein the bending angle of the second zigzag slits of the touch driving electrode is different with the bending angle of the second zigzag slits of the touch sensing electrode.

9. The touch control substrate according to claim 1, wherein the touch control region further comprises a gap region with a plurality of third zigzag slits, the gap region being arranged between the touch driving electrode and the touch sensing electrode; wherein the third zigzag slit is not parallel to the second zigzag slit.

10. A display panel comprising the touch control substrate according to claim 1.

11. The display panel according to claim 10, wherein the shadow elimination layer and the touch control electrode are arranged in the same layer.

12. The display panel according to claim 10, wherein the bending direction of the first zigzag slit is contrary to the bending direction of the second zigzag slit.

13. The display panel according to claim 10, wherein the bending direction of the first zigzag slit is same with the bending direction of the second zigzag slit; wherein the bending angle of the first zigzag slit is different with the bending angle of the second zigzag slit.

14. The display panel according to claim 10, wherein the touch control electrode comprises a touch driving electrode and a touch sensing electrode arranged in the same layer; wherein the touch driving electrode and the touch sensing electrode comprise the second zigzag slits respectively.

15. The display panel according to claim 14, wherein the second zigzag slit of the touch driving electrode is not parallel to the second zigzag slit of the touch sensing electrode.

16. The display panel according to claim 10, wherein the touch control region further comprises a gap region with a plurality of third zigzag slits, the gap region being arranged between the touch driving electrode and the touch sensing electrode; wherein the third zigzag slit is not parallel to the second zigzag slit.

17. A method for manufacturing a touch control substrate, comprising: forming a wiring region and a touch control region; and forming a shadow elimination layer with a plurality of first zigzag slits in the wiring region; the touch control region comprising a touch control electrode with a plurality of second zigzag slits; the first zigzag slit being not parallel to the second zigzag slit.

18. The method according to claim 17, wherein the shadow elimination layer and the touch control electrode are arranged in the same layer.

19. The method according to claim 17, wherein the touch control electrode comprises a touch driving electrode and a touch sensing electrode arranged in the same layer; wherein forming a touch control region comprises:
arranging the touch driving electrode and the touch sensing electrode in the same layer with a transparent material; forming a plurality of second zigzag slits on the touch driving electrode and the touch sensing electrode, the second zigzag slit of the touch driving electrode being not parallel to the second zigzag slit of the touch sensing electrode.

20. The method according to claim 19, wherein the method further comprises:
forming a gap region with a plurality of third zigzag slits, the gap region being arranged between the touch driving electrode and the touch sensing electrode; wherein the third zigzag slit is not parallel to the second zigzag slit.
